(19) United States
(12) Patent Application Publication
(10) Pub. No.: US 2013/0308018 A1
(43) Pub. Date: Nov. 21, 2013

(54) IMAGE PROCESSING APPARATUS, IMAGING APPARATUS, AND IMAGE PROCESSING METHOD

(71) Applicant: CANON KABUSHIKI KAISHA, Tokyo (JP)

(72) Inventor: Kenichi Sasaki, Yokohama-shi (JP)

(73) Assignee: CANON KABUSHIKI KAISHA, Tokyo (JP)

(21) Appl. No.: 13/892,790

(22) Filed: May 13, 2013

(30) Foreign Application Priority Data
May 17, 2012 (JP) 2012-113572

(51) Int. Cl. H04N 5/217; G06K 9/36

(52) U.S. Cl. CPC H04N 5/217; G06K 9/36
USPC 348/242; 382/167

(57) ABSTRACT

An image processing apparatus includes an acquisition unit configured to divide an image into a plurality of areas and to acquire an object distance and a defocus amount in each area, and a processing unit configured to obtain, for each area, a correction amount corresponding to the object distance and the defocus amount and to perform correction processing for correcting lateral chromatic aberration based on the correction amount.

### BACKGROUND OF THE INVENTION

1. Field of the Invention

The present invention relates to a technique for processing an image captured via an imaging optical system.

2. Description of the Related Art

In an imaging apparatus, such as a compact digital camera, it is known that barrel distortion generates at a wide-angle side of a zoom lens. There is such a configuration that, in designing the imaging apparatus, a distortion amount remaining in an optical lens is increased to correct the distortion generated in an image signal obtained when capturing an image by digital image processing. A correction of distortion by the digital image processing is typically performed such that the barrel distortion generated at a wide-angle end is corrected by enlargement/movement processing and interpolating processing of the image.

Allowance of remaining of the distortion in the optical lens increases freedom of the design of the optical lens. As a result, reduction of the number of lenses, down-sizing of the lenses to be used, or reduction of cost tends to be achieved with ease.

It is known that barrel distortion changes depending on a distance to an object being imaged, and thus it can be corrected accordingly. Japanese Patent Application Laid-Open No. 2008-286548 discusses a calculation method employed when a correction of barrel distortion is changed according to the distance to an object.

Similarly, such a case is increasing that the amount of lateral chromatic aberration (chromatic aberration of magnification) remaining in the optical lens is designed to be increased. Lateral chromatic aberration generally corresponds to a case that different distortions remain in various color channels, such as R (red), G (green), and B (blue) channels. A correction of distortion caused by chromatic aberration is performed separately for each color channel to uniform a distortion amount between color channels, thereby enabling a lateral chromatic aberration correction by the digital image processing.

However, in the case of the lateral chromatic aberration correction, a slight difference between channels needs to be matched, so that more accurate correction than the correction of distortion in which the distortion is simply reduced is required.

Lateral chromatic aberration is lateral aberration, whereas, longitudinal aberration is chromatic aberration in which an image formation point shifts in aback-and-forth (i.e., an optical axis) direction with respect to an image plane on an axis per each color channel in off-axis. In other words, curvature of field differs for each color channel, such that each color channel is slightly defocused. When axial chromatic aberration corresponding to longitudinal aberration is generated, color fringe is seen such that the color fringe encloses an object image around a peripheral portion of the image. On the other hand, when lateral chromatic aberration corresponding to lateral aberration is generated, the color fringe is seen at either one of the edge portion of an image center side of the object image or an edge portion of the other side thereof.

With reference to Japanese Patent Application Laid-Open No. 2006-14261, the above described color fringe is sometimes referred to as a purple fringe in the case of, for example, bleeding of violet, and the color bleeding is attempted to be reduced by a saturation adjustment and interpolating processing.

In the art discussed in Japanese Patent Application Laid-Open No. 2008-286548, since distortion depends on the distance to an object, a different correction curve is used for each distance. However, in a case where all the objects to be captured in the same image are not in an in-focus state, there is such a problem that a satisfactory correction cannot be made. In other words, even with conditions of correction of distortion for different distances, it seldom occurs that all the objects are in an in-focus state. A case where all the objects of the different distance are placed in an in-focus state is limited to a case where those objects are within the same depth of field.

For example, in a case where a plurality of objects existing at different distances is captured, there is a case where main objects are placed in an in-focus state and objects which are not contained within the depth of field at the time, i.e., objects placed in an out-of-focus state, may also be included in the same image. Those main objects are included in the same image in a defocus state, e.g., in a slightly defocused state or in a greatly defocused state.

The present inventor found that, in such a case, even when a correction of distortion amount for each distance of the object is used, a satisfactory correction cannot made.

More specifically, in a case where a correction is made also with respect to lateral chromatic aberration by correcting distortion for each color channel, even if an effective distortion correction amount is prepared for the objects in an in-focus state, a satisfactory correction cannot be made with respect to the objects in an out-of-focus state with data of this correction amount. In other words, with respect to the objects existing at distances greatly different from the distances of the objects in an in-focus state, there is a case that a fringe with a color arises at an edge portion and a case that a blurred color makes the objects in a defocused state to be contaminated.

With respect to a color bleeding such as a purple fringe as discussed in Japanese Patent Application Laid-Open No.2006-14261, there is such a problem that a satisfactory correction cannot be made with respect to objects in an out-of-focus state.

### SUMMARY OF THE INVENTION

According to an aspect of the present invention, an image processing apparatus includes an acquisition unit configured to divide an image into a plurality of areas and to acquire an object distance and a defocus amount in each area, and a processing unit configured to obtain, for each area, a correction amount corresponding to the object distance and the defocus amount and to perform correction processing for correcting lateral chromatic aberration based on the correction amount.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of a digital camera as an image processing apparatus according to an exemplary embodiment of the present invention.

FIG. 2 illustrates a state that a color edge is defocused to be blurred.

FIG. 3 is a schematic view illustrating a concept of distortion of each color channel, i.e., lateral chromatic aberration.

FIG. 4 illustrates a method for defining the color edge by defocusing.

FIG. 5 illustrates divided areas on an image.

FIG. 6 schematically illustrates a case where objects at different distances have been captured in an image.

FIGS. 7A and 7B each schematically illustrates a state that lateral chromatic aberration differs according to an image height.

FIG. 8 schematically illustrates a concept for correcting lateral chromatic aberration for each area.

FIG. 9 schematically illustrates a concept of curvature of field.

### DESCRIPTION OF THE EMBODIMENTS

Various exemplary embodiments, features, and aspects of the invention will be described in detail below with reference to the drawings.

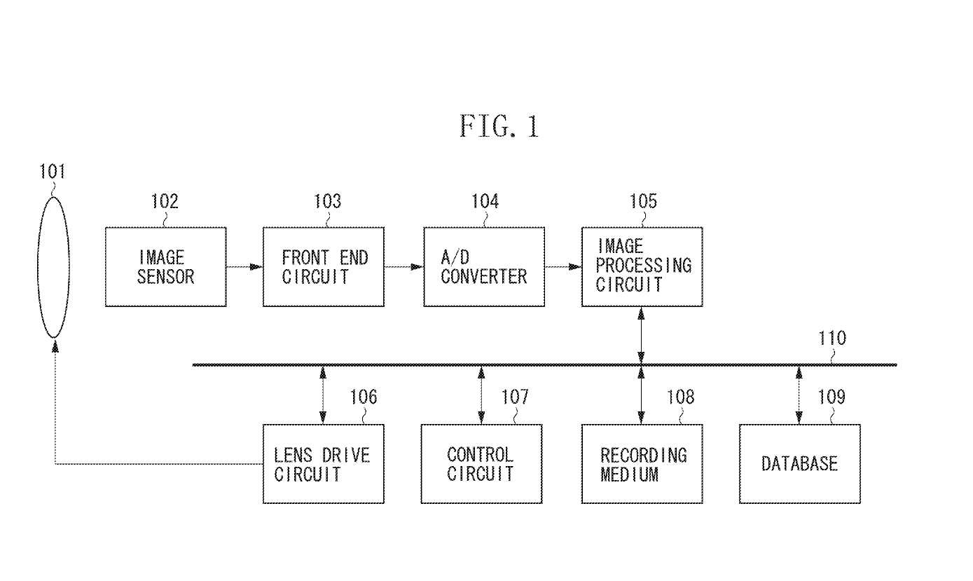

FIG. 1 illustrates a schematic configuration of a digital camera as an image processing apparatus according to an exemplary embodiment of the present invention. In FIG. 1, an optical system 101 includes a lens group including a zoom lens and a focus lens, a diaphragm device, and a shutter device. The optical system 101 adjusts a magnification and a point of focus or a light intensity of an object image which reaches an image sensor 102. The image sensor 102 is a photoelectric conversion element, such as a charge-coupled device (CCD) sensor and a complementary metal-oxide semiconductor (CMOS) sensor. The image sensor 102 converts an object image into an electrical signal to generate an image signal. In the present exemplary embodiment, the image sensor 102 includes a CCD sensor having a Bayer array including R (red), G (green), and B (blue) filters.

A front end circuit 103 includes a correlated double sampling (CDS) circuit and an amplifier circuit. The CDS circuit controls a dark current contained in an image signal generated in the image sensor 102 and the amplifier circuit amplifies the image signal output from the CDS circuit. An analogue-to-digital (A/D) converter 104 converts the image signal output from the front end circuit 103 into a digital image signal.

An image processing circuit 105 performs white balance correction processing, noise control processing, gradation converting processing, and edge intensifying correction processing on the image signal to thereby output the image signal in the form of a luminance signal Y and color-difference signals U and V. The image processing circuit 105 also calculates a focusing value indicating a luminance vale of the object and a focusing state of the object based on the image signal. The focusing value can be obtained from contrast information of the object. As the contrast in a specific frequency becomes higher, the focusing value becomes larger. The image processing circuit 105 can perform similar image processing also on an image signal read out from a recording medium 108 in addition to the image signal output from the A/D converter 104. The image processing circuit 105 further generates image data by performing a coding process in order to record the image signal on the recording medium 108. The image processing circuit 105 still further decodes the image signal by performing a decoding process of the image data recorded on the recording medium 108.

A lens drive circuit 106 drives a lens group included in the optical system 101 according to an instruction from a control circuit 107 to change a zoom state and a focus state of the optical system 101.

The control circuit 107 controls each of the circuits constituting the digital camera of the present exemplary embodiment to cause the digital camera to operate as a whole. Based on a luminance value and a focusing value obtainable from the image signal processed by the image processing circuit 105, the control circuit 107 also controls driving of the lens drive circuit 106 and the image sensor 102. The control circuit 107 causes the lens drive circuit 106 to move the focus lens included in the optical system 101 and obtains a focusing value corresponding to a position of each focus lens from the image processing circuit 105, thereby being capable of obtaining a focus position of each object . The control circuit 107 may be implemented by, for example, a microprocessor.

A recording medium 108 records an encoded image signal, e.g., a semiconductor memory such as a flash memory and a Secure Digital (SD) card, and an optical/magnetic recording medium, e.g., a Blur-ray disc, a digital versatile disc (DVD), a compact disc (CD), and a tape. The recording medium 108 may be configured to be detachable from the digital camera or may be built in the digital camera.

A database 109 previously stores an aberration correction amount of each color. The database 109 stores data capable of obtaining the aberration correction amount for each area divided according to a defocus amount, an object distance, and an image height of the optical system 101.

A bus 110 is used for transmitting images and instructions between the image processing circuit 105, the lens drive circuit 106, the control circuit 107, the recording medium 108, and the database 109.

The image processing circuit 105 performs the correction of distortion of the image signal with respect to each of the color channels of R (red), G (green), and B (blue), respectively, by the digital image processing. As a result, a lateral magnification difference generated around an image peripheral portion can be reduced and a color misregistration can be decreased. The distortion varies according to a distance to the object and also varies according to a focusing state.

The control circuit 107 causes the image processing circuit 105 to operate with the lens drive circuit 106 to bring into focus a desired main object for capturing an image thereof. At the time of capturing the image of the main object, there may be a case where an object which is out of the depth of field of the main object and which is defocused to the extent that the conditions for correcting lateral chromatic aberration is varied may be included in the same image.

As described above, the control circuit 107 can obtain a focus position of each of the objects. Therefore, the image processing circuit 105 obtains an object distance of each object in the image and performs the correction of distortion by using an image height, an object distance of each object, and distortion correction amount information of each color channel.

In autofocus (AF) control, a TV-AF method and a hill-climbing AF method are typical methods for an auto-focus type digital camera. In the present embodiment, while allowing the focus lens included in the optical system 101 to scan (i.e., allowing auto focus (AF) scanning) in an extend/withdraw direction, the contrast (i.e., the focusing value) at a predetermined portion in the image obtained by the image processing circuit 105 is observed. In this manner, while the image or a portion thereof is observed, a focus position at which the contrast becomes the largest is established as an in-focus position. To that end, the control circuit 107 divides the image into a plurality of areas to detect a focus position in each area based on the focusing value obtained from the image processing circuit 105, thereby being capable of obtaining an object distance for each area.

On the other hand, the distortion amount when each object distance comes into focus of each of the color channels of R, G, and B in each image height can be calculated based on an image-taking lens design value in consideration with a manufacturing error. A defocused state of each color channel in the case of being out of focus, i.e., being defocused, can also be preliminarily calculated based on the design value and a measured value.

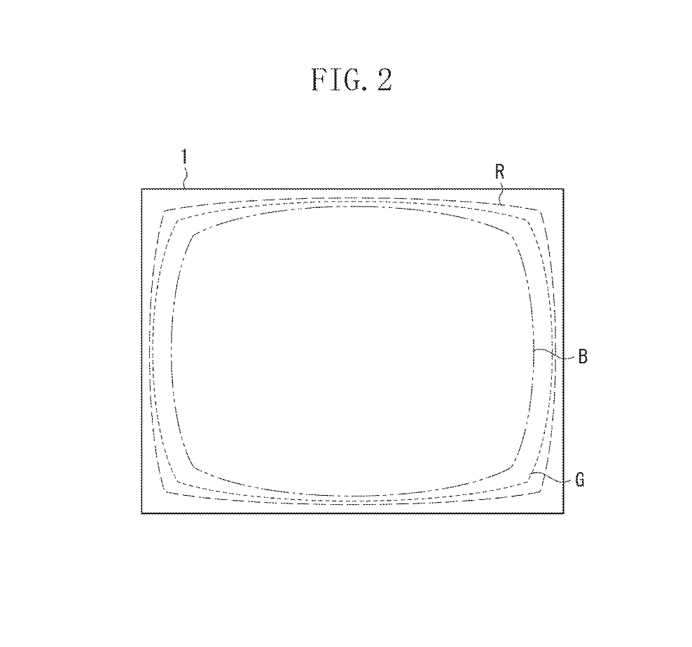

FIG. 2 schematically illustrates an appearance of distortion of each of the color channels of R, G, and B. More specifically, FIG. 2 illustrates shifting of an image forming position of each of the colors of R, G, and B with respect to the outer edge of an image 1 in a state that the frames R, G, and B include distortion of each of the colors of R, G, and B (before correcting distortion). As described above, the distortion amount in each of the color channels differs in the same shooting distance. Each of the frames R through B illustrated in FIG. 2 represents an image height ratio in a case where all the positions are in an in-focus state within the image. More specifically, this corresponds to a case where an image of a planar object is captured in an in-focus state. There is a plurality of distortions in the respective color channels corresponding to different object distances.

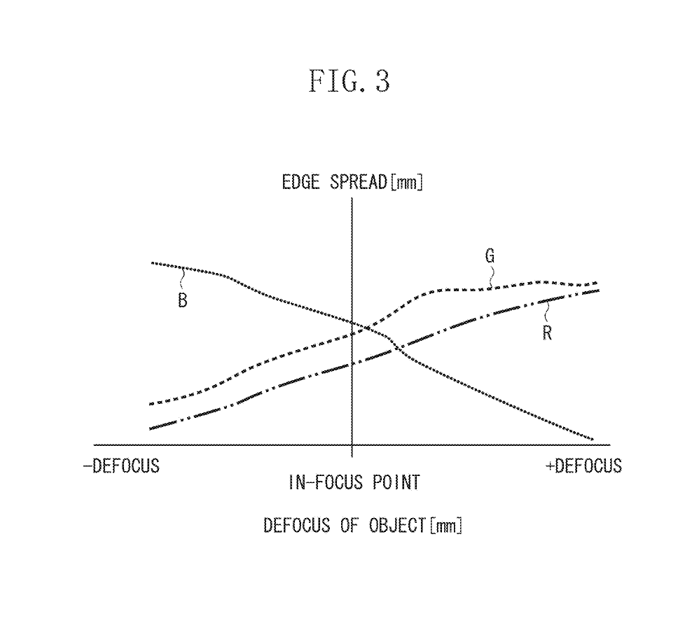

FIG. 3 illustrates the spread of an edge image of each color due to a defocused state of an image according to the defocus amount in an image height at a shooting distance. At a position other than the in-focus position (IN-FOCUS POINT in FIG. 3), the edge portion of the image comes out of focus and, thus, the edge portion is formed into a blurred image. The size of the spread of the color due to the defocused state of the image is evaluated by an evaluation amount in consideration with color saturation and brightness. The length of an expanding amount/contracting amount of the edge image (including the defocused range thereof) in a certain condition is represented by coordinates at which the evaluation amount becomes equivalent to a predetermined threshold.

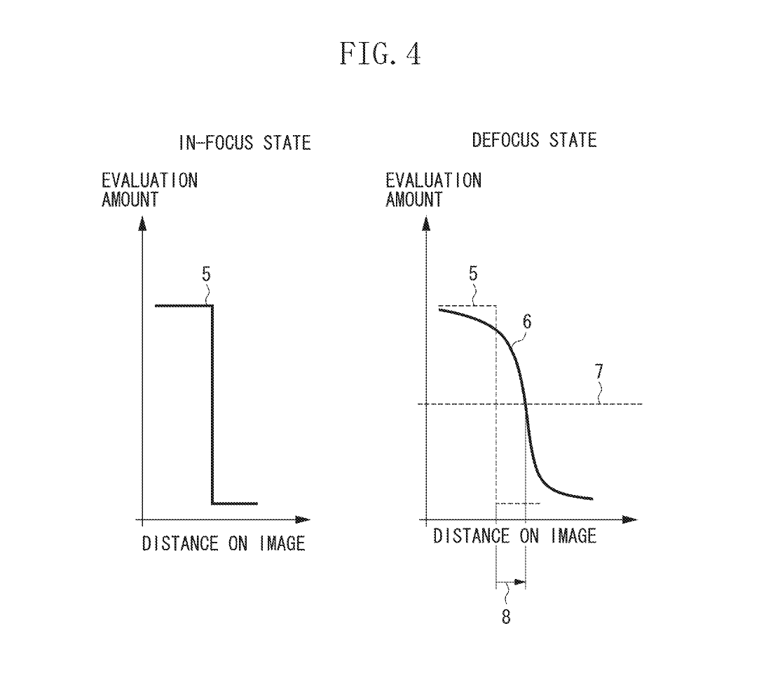

FIG. 4 schematically illustrates exemplary functions used to calculate the spread of the edge image. In FIG. 4, a line 5 represents a function of an edge image of a color channel in an in-focus state by an evaluation amount determined in consideration of color saturation and brightness. The edge image corresponds to a boundary area between two signals having different values and, in the case of an in-focus state, an ideal evaluation amount of the edge image linearly changes as illustrated in the left graph of FIG. 4. The coordinates at which the evaluation amount becomes equivalent to a predetermined threshold in an in-focus state is considered as a reference point when the spread of the edge image is calculated. On the other hand, when the object comes out of an in-focus state, i.e., comes into a defocus state, the edge image is blurred and the evaluation amount thereof is represented by a curve 6. The coordinates at which the evaluation amount represented by the curve 6 reaches a predetermined threshold 7 are calculated to define a shifting amount of the coordinates from the reference point of an in-focus state as a spread (distance) 8 of the edge image.

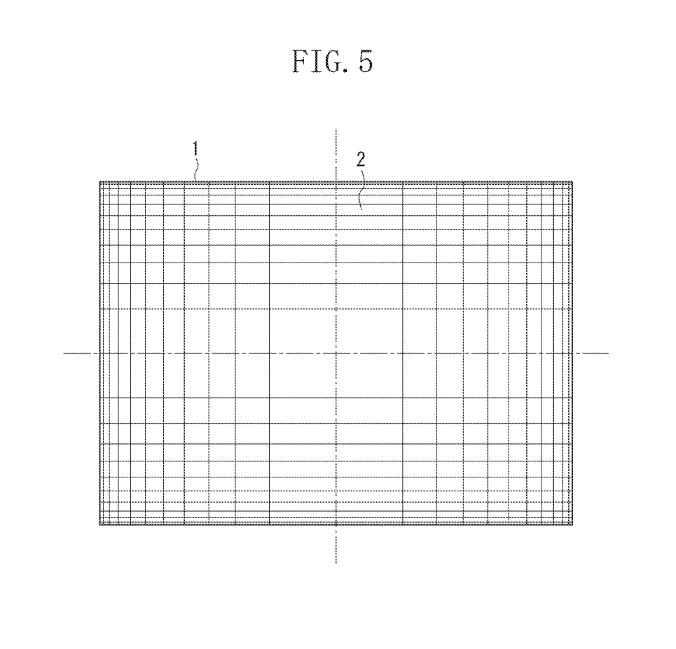

FIG. 5 illustrates an example of an image plane divided into a plurality of areas 2. The plurality of areas 2 is set so as to be coarser in the areas near to the center of the image, and finer in the areas away from the center of the image. The control circuit 107 is configured to determine an object distance and a focusing state in each of the areas. Generally, as the image height becomes higher, the distortion amount and the lateral chromatic aberration amount become larger; however, the amount of change depends on the optical characteristics of the imaging lens, e.g., the lens diameter, curvature, optical power, average refractive index, etc. For this reason, the illustrated division intervals of the plurality of areas 2 may be determined in accordance with an amount of distortion of a certain image-taking lens. In other words, the image is divided into areas 2 so as to correspond to an optical distortion remaining in the imaging optical system. The image is divided into a plurality of areas 2 such that the areas are coarser (larger) in the image height including a small distortion amount (e.g., the central or on-axis region of the lens), whereas, the areas become finer (smaller) in the image height including a larger distortion amount (e.g., the peripheral or off-axis region of the lens). Therefore, the division number of the areas maybe changed according to a change in the amount of distortion with respect to the image height.

In the example illustrated in FIG. 5, the image is divided into areas mainly in vertical and horizontal directions in consideration of the speed of digital image processing. However, in a case where the characteristics of the imaging optical system are mainly considered, there are cases where a division in a concentric direction or in a radial direction is desirable. In the present embodiment, the description is made provided that the center of the captured image corresponds to the center of the optical axis of the optical system 101. If the center of the captured image does not corresponds to the center of the optical axis, the image height needs to be calculated with reference to the center of the optical axis.

When performing the AF scanning (i.e., when obtaining an image), the control circuit 107 acquires distance information of an object included in the image for each of the areas 2, divided in the manner as illustrated in FIG. 5, regardless of an in-focus state or an out-of focus state. Then, when attaining an in-focus state on a main object, the control circuit 107 determines an object distance for each of the areas 2 of the image. As a matter of course, there is such a case that objects other than the main object are out of focus in the image, i.e., are in a defocused state in the image. The control circuit 107 calculates a defocus amount in each of the areas 2 based on a difference between the object distance of each of the areas 2 and the object distance of an area where the main object exists. The control circuit 107 then stores the calculation result in a storage medium, such as memory (not illustrated) together with the object distance.

The database 109 stores a distortion correction amount for each object distance and for each defocus amount of each of the areas 2 based on previously established lens design values. For example, as described above, lens design values and manufacturing tolerances for each type of imaging lens can be correlated to each of areas 2 and stored in advance in database 109. In other words, the distortion correction amount according to a setting state of the optical system 101, e.g., a lens position and a diaphragm, and an image height of an image is stored in the database 109. In the digital camera according to the present exemplary embodiment, in addition to the distortion correction amount according to the setting state of the optical system 101 and the image height of the image, the database 109 stores the distortion correction amount according to the object distance and the defocus amount of the object. Accordingly, the image processing circuit 105 receives the object distance and the defocus amount of each of the areas 2 from the control circuit 107 and reads out the corresponding distortion correction amount stored in the database 109. As a result, an appropriate correction of distortion according to the area (i.e., the image height) where the object exists and the defocus amount of the object for each color can be realized with respect to all of the objects. Thus, lateral chromatic aberration and barrel distortion can be eliminated at the same time.

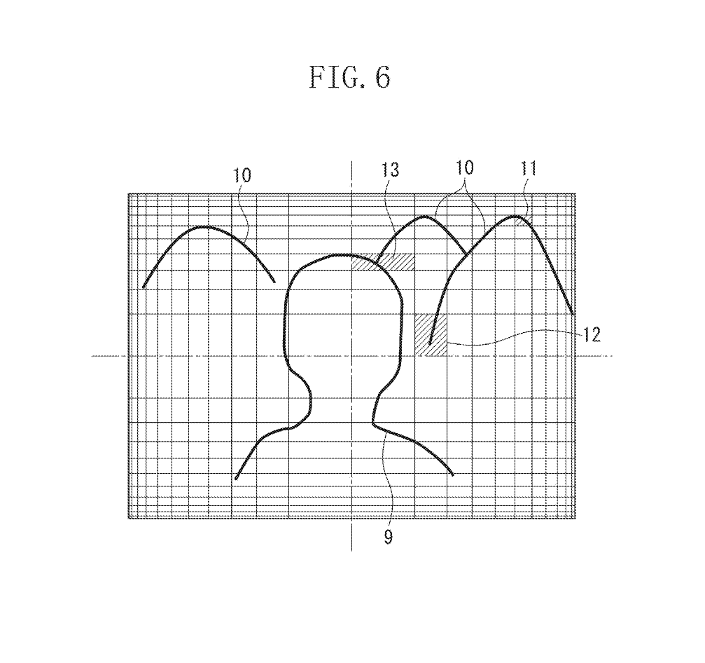

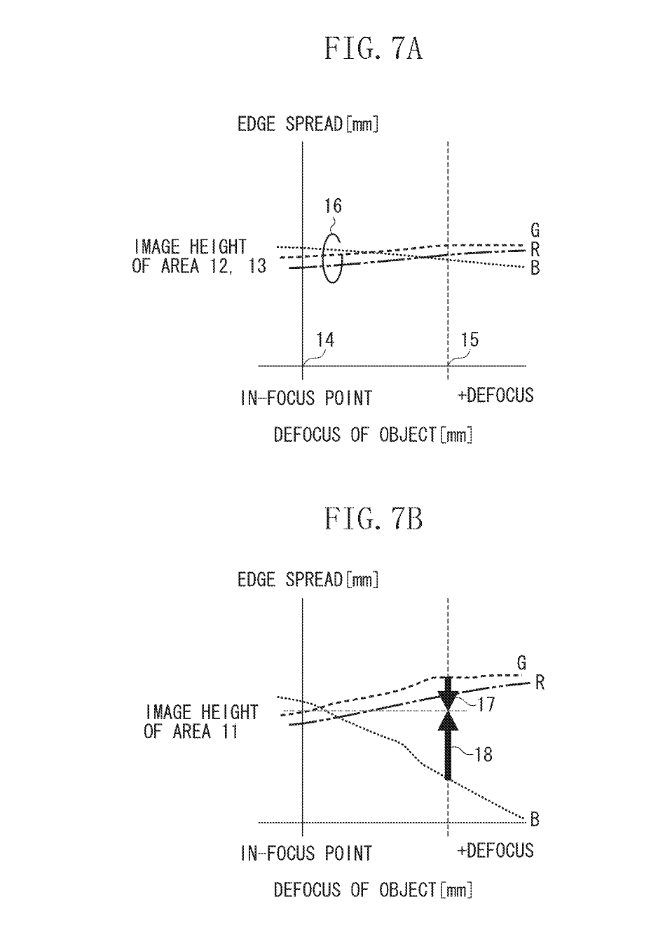

FIG. 6 illustrates an example in which a main object (e.g., a person) 9 in close range and a background scene 10 are included in the image at the same time. The background scene 10 is a distant view in a defocus state. An area 11 illustrated in FIG. 6 includes the background scene 10 having a high image height and existing distantly in a defocus state. An area 12 includes the background scene 10 having a low image height and existing distantly in a defocus state. An area 13 mixedly includes both the background scene 10 having a low image height existing distantly in a defocus state and the main object 9 (e.g., a person) focused in a short range (both having the low image heights). FIGS. 7A and 7B each schematically illustrate a graph of an edge spread amount of each of the color channels of R, G, and B according to the defocus amount in each of the areas 11, 12, and 13. The graphs of FIG. 7A and 7B are illustrated in a similar manner as illustrated in FIG. 3.

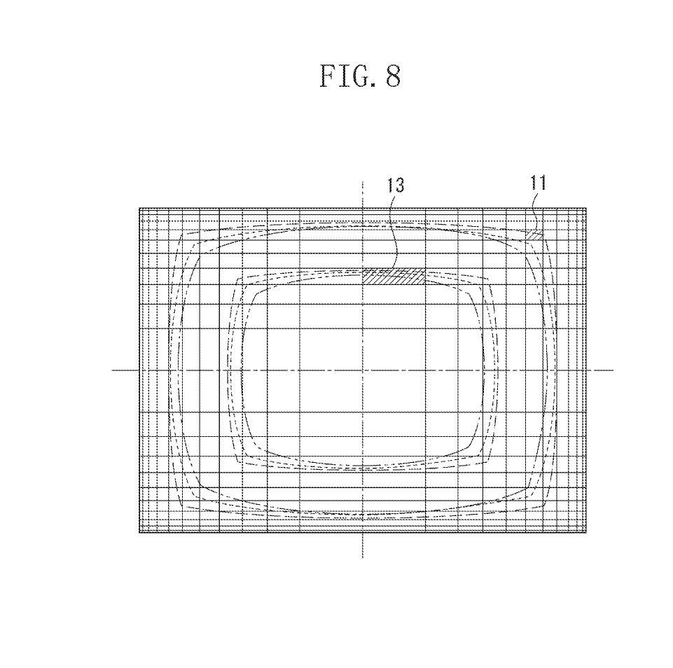

In FIG. 7A, the position of an in-focus point 14 shown by a solid line extending perpendicularly over the horizontal axis indicates an object distance of the main object 9 in an in-focus state, and a position 15 of a dotted line extending perpendicular over the horizontal axis indicates an object distance (i.e., a defocus amount) of the background 10 in each area. FIG. 7A illustrates edge spreads in the areas 12 and 13. FIG. 7B illustrates an edge spread in the area 11. The edge spread amount of each of the color channels of R, G, and B with respect to the defocus amount illustrated by the dotted line 15 differs between the area 11, the area 12, and the area 13 having different image heights. The edge spread amount of G and the edge spread amount of B in the area 11 are indicated, respectively, by arrows 17 and 18. Based on the edge spread amounts shown by arrows 17 and 18, the distortion correction amount of each color of the area 11 is changed. In the present exemplary embodiment, a schematic view of the concept for correcting distortion for each area is illustrated in FIG. 8. Distortion of each of the color channels of R, G, and B is larger in the area 11 than in the area 13. Accordingly, lateral chromatic aberration also becomes larger in the area 11 than in the area 13. Therefore, distortion is to be corrected for each area.

Even if the main object 9 focused in close range and the background 10 positioned distantly in a defocus state are mixed in one area as in the case of the area 13, since the image height thereof is low, the edge spread of each color due to defocusing is small and thus can be ignored. The higher the image height is, the finer the area is sectioned. Therefore, a mixture of objects hardly occurs. In a case where an unavoidable mixture of main object and background scene occurs, correction would be preferentially performed on a main object which is in an in-focus state, but the opposite may also be accomplished.

As described above, there is such a problem that optical curvature of field remaining in the imaging optical system differs between color channels of R, G, and B.

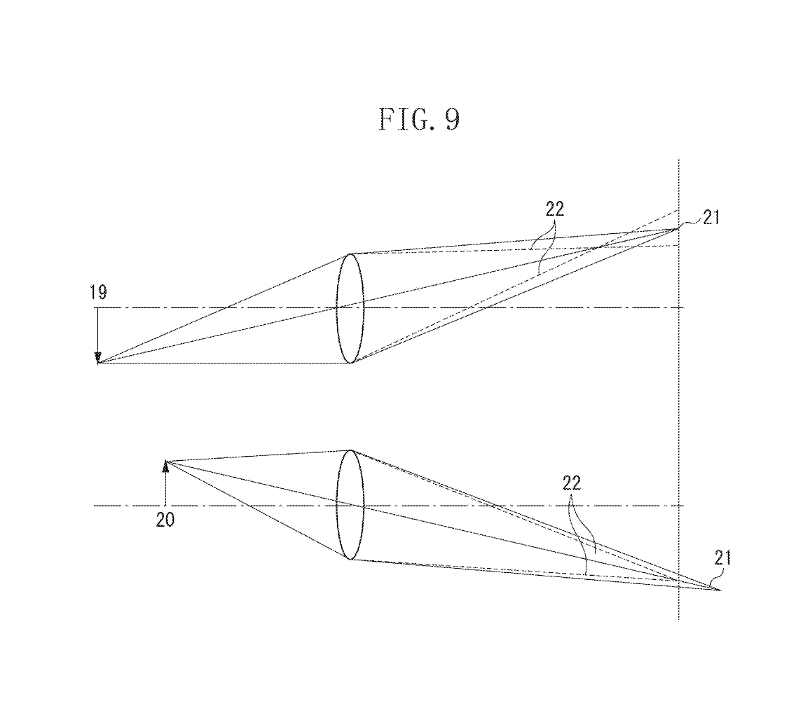

As illustrated by the upper view of FIG. 9, with respect to a main object 19, a G image 21 among the R, G, and B images comes into focus on an image sensor (not illustrated), whereas, there is a case where an R image or a B image 22 come into focus on somewhere in front of the G image 21 although the R image and the B image 22 are the same object images as the G image. This means that the image planes of the R and B channels are curved into an underside with respect to the image plane of the G channel. The image obtained at that time is viewed with a fringe (i.e., a color frame) due to the aberration generated by the curvature of field, the fringe being formed because of a color misregistration or defocusing of the R image and the B image around the edge of the G image. At the same time, as illustrated by the lower view of FIG. 9, in a case where another object 20 at a side closer than the main object 19 is included in the same image, the R image or the B image 22 is focused on the image sensor, whereas, the G image 21 comes into focus on the rear side of the image sensor to be defocused into the over side. As a result thereof, the image is viewed with a color fringe.

In this case, also, similarly, by using information of the image height and the object distance for each area, the color misregistration portion or the colored portion is provided with processing for reducing the above-described phenomenon by a selective adjustment of color saturation and brightness or interpolating processing. Accordingly, even in a case where a plurality of objects having different distances are mixed in the same image plane in a defocus state, aberration due to curvature of field can be corrected in an appropriate manner.

As described above, in addition to an object distance, a defocus amount of the object is also considered to correct aberration for each color, color misregistration generated in the image can be corrected in a suitable manner.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-113572 filed May 17, 2012, which is hereby incorporated by reference herein in its entirety.

What is claimed is:

1. An image processing apparatus comprising:
an acquisition unit configured to divide an image into a plurality of areas and to acquire an object distance and a defocus amount in each area; and
a processing unit configured to obtain, for each area, a correction amount corresponding to the object distance and the defocus amount and to perform correction processing for correcting lateral chromatic aberration based on the correction amount.

2. The image processing apparatus according to claim 1, wherein the processing unit obtains, for each area, the object distance, the defocus amount, and a correction amount corresponding to an image height of each area.

3. The image processing apparatus according to claim 1, wherein the acquisition unit divides the image into the plurality of areas based on a characteristic of an optical system included in an imaging unit that acquires the image.

4. The image processing apparatus according to claim 3, wherein, in the plurality of areas, each area is smaller as an image height with reference to an optical axis of the optical system is larger.

5. The image processing apparatus according to claim 1, wherein the processing unit performs the correction processing for correcting lateral chromatic aberration by obtaining a correction amount of distortion corresponding to the object distance and the defocus amount for each of a plurality of colors constituting the image and correcting distortion based on the correction amount of distortion.

6. An imaging apparatus comprising:
an imaging unit configured to capture an image;
an acquisition unit configured to divide the image into a plurality of areas and to acquire an object distance and a defocus amount in each area; and
a processing unit configured to obtain, for each area, a correction amount corresponding to the object distance and the defocus amount and to perform correction processing for correcting lateral chromatic aberration based on the correction amount.

7. An image processing method comprising:
dividing an image into a plurality areas and acquiring an object distance and a defocus amount in each area; and
obtaining, for each area, a correction amount corresponding to the object distance and the defocus amount and performing correction processing for correcting lateral chromatic aberration based on the correction amount.
